(19) United States
(12) Patent Application Publication
(10) Pub. No.: US 2014/0229703 A1
(43) Pub. Date: Aug. 14, 2014

(54) INFORMATION PROCESSING METHOD, NON-TRANSITORY COMPUTER READABLE MEDIUM HAVING PROGRAM STORED THEREON, AND INFORMATION PROCESSING APPARATUS

(71) Applicant: Nozomi Ishihara, Tokyo (JP)

(72) Inventor: Nozomi Ishihara, Tokyo (JP)

(73) Assignee: NEC CORPORATION, Minato-ku, Tokyo (JP)

(21) Appl. No.: 14/008,595

(22) PCT Filed: Nov. 11, 2011
(86) PCT No.: PCT/JP2011/006322

§ 371 Date: Sep. 30, 2013

(30) Foreign Application Priority Data
Mar. 31, 2011 (JP) 2011-079973

(51) Int. Cl. G06F 12/10

(52) U.S. Cl. CPC G06F 12/109; G06F 2212/657
USPC 711/209

(57) ABSTRACT

A control unit of an information processing apparatus extracts an address string of memory access generated in a processor executing a program in an arbitrary computer, divides the address string into a plurality of sections. And the control unit searches an address pattern accessible by an address generator that converts a command to be input into an address string including a plurality of address block numbers by a predetermined algorithm for the each divided section.

### TECHNICAL FIELD

The present invention relates to an information processing method, a non-transitory computer readable medium having a program stored thereon, and an information processing apparatus and, in particular, to an information processing method, a non-transitory computer readable medium having a program stored thereon, and an information processing apparatus that can efficiently generate control information for an address generator.

### BACKGROUND ART

In a certain type of signal processing algorithm, a data format in a processor inputting and outputting to and from a memory is previously specified. Therefore, there has been known that the processor need not perform processing of memory access by using an address generator that automatically reads data having such format from the memory, and that the number of processing cycles can be reduced.

There is included a GAG (Generic Address Generator) as a conventional art of the address generator (Non Patent Literature 1).

A configuration of an apparatus including the GAG is shown in FIG. 4. The apparatus pertaining to FIG. 4 is provided with a memory in which the GAG and control information for controlling the GAG have been stored. The GAG receives the control information from the memory, and performs processing according to the control information. The memory gives the GAG Base, Inner Loop limit, Inner Loop step, Outer Loop limit, and Outer Loop offset as the control information.

The GAG operates in accordance with an algorithm defined by a loop structure. Base value, Limit and Step of Inner Loop, and Limit and Step of Outer Loop, which are the control information, are parameters that define operation of this loop structure. In addition, the GAG can operate in accordance with a plurality of loop structures. For example, operation of the GAG of FIG. 4 is defined by at least loop structures 1 and 2. In this case, the GAG starts operation pertaining to the loop structure 2, after ending operation pertaining to the loop structure 1.

Operation of address generation by this GAG will be described using FIG. 5. Only operation pertaining to the loop structure 1 will be described here. Control information pertaining to the loop structure 1 is, as shown in FIG. 4, as follows: Base: 0; Inner Loop limit: 2; Inner Loop step: 1; Outer Loop limit: 2; and Outer Loop offset: 4. A memory space that the GAG accesses shall have 8 words as shown in FIG. 5. In addition, a block number that the GAG actually accesses is indicated by a black circle and an arrow in FIG. 5. First, the GAG accesses an address corresponding to a given Base. Since the Base is 0 in this example, the GAG accesses the block number 0 of the memory.

Next, the GAG starts execution of Inner Loop. More specifically, the GAG accesses an address in which the step has been added to the Base, and repeats the access limit times. Since the step is 1 in this example, the GAG first accesses a block number 1 in which 1 has been added to the Base. Next, when the GAG performs decrement of a limit value, and the limit value is not 0, the GAG again executes addition of the above-mentioned step value and memory access. In a case of this example, since an initial value of the limit is 2, the decremented limit is 1. Consequently, the GAG next accesses a block number 2 in which the step value 1 has been further added to the previously accessed address (the block number 1). After that, the GAG performs decrement of the limit value again. Since the limit value becomes 0 here, the GAG ends processing of the Inner Loop.

Subsequently, the GAG executes Outer Loop. More specifically, the GAG decrements a limit value of the Outer Loop at the same time when the first Inner Loop is ended, and when the limit value is not 0, the GAG updates the Base with a value in which the step has been added to the Base. After such processing, the GAG executes the Inner Loop again. Since the initial value of the limit is 2 in this example, the limit value is first decremented to 1. Next, the GAG adds a step value 4 to the current Base value 0, and sets an addition result 4 as a new Base value. After that, the GAG executes the Inner Loop again. When the Inner Loop is ended, the GAG decrements the limit value by 1 again. Here, since the limit becomes 0, the GAG ends the Outer Loop.

The processor can perform efficient memory access by utilizing such GAG.

In Non Patent Literature 1, there is shown a method, through a simple example, for generating Base, Inner Step, Outer Step, Inner Loop Limit, and Outer Loop Limit that are used for performing access, when one certain address string that the GAG should access is decided.

### CITATION LIST

### Non Patent Literature

### Non Patent Literature 1

Reiner W. Hartenstein, “Exploiting Contemporary Memory Techniques in Reconfigurable Accelerators”, Proceedings of 8th International workshop on Field-Programmable Logic and Applications: FPL '98, Estonia, on Sep. 3, 1998

### SUMMARY OF INVENTION

### Technical Problem

The inventor of this application has examined a method for generating control information (Base, step and limit of Inner Loop, and step and limit of Outer Loop: hereinafter referred to as a command) for controlling the GAG as mentioned above using a computer. One method for generating the command for the GAG is the method in which the computer analyzes a target address string in order from a head, and generates the corresponding command.

For example, processing will be considered in which the computer generates a command for the GAG to access an address string shown in FIG. 3. The computer first generates a command (it is set as a command 1) for accessing an address of a leading cycle (cycle 0) of this address string. Next, the computer changes a part of the command (Inner Loop limit and Inner Loop step, and Outer Loop limit and Outer Loop step), and thereby tries to generate a command (it is set as a command 1′) that can achieve both access to the address of the cycle 0 and access to an address of a next cycle (cycle 1). If being able to generate the command 1′ here, the computer employs the command 1′. Meanwhile, if not being able to generate the command 1′, the computer generates a new command (it is set as a command 2) for accessing the cycle 1, after once outputting the command 1 for accessing the cycle 0 as a generation result. Subsequently, the computer performs similar processing of a cycle 2. Namely, the computer changes a part of the above-mentioned command 1′ or command 2, and thereby tries to generate a command that can achieve access to an address of the cycle 2. Hereinafter, the computer performs similar processing until a last cycle (cycle 7).

The above-mentioned operation of the computer will be shown more specifically. In the address string of FIG. 3, the address of the cycle 0 is “0”. The computer finds out as a result of trial and error that this address can be accessed by a command of Base=0, Inner Loop limit=1, Outer Loop limit=1, Inner Loop Step=0, and Outer Loop Step=0. This command is set as the command 1.

Next, the address of the cycle 1 is “0”. The computer finds out as a result of trial and error that this address can also be accessed by the same command if Inner Loop limit=2 is set in the previously generated command 1. Consequently, the computer changes the Inner Loop limit of the previously generated command 1 to 2. This changed command is set as the command 1′.

Subsequently, the address of the cycle 2 is “1”. This address cannot be represented by the previously generated command 1′. Consequently, the computer ends generation of the command 1′, and newly starts generation of the command 2. The computer finds out as a result of trial and error that this address can be accessed by a command of Base=2, Inner Loop limit=1, Outer Loop limit=1, Inner Loop step=0, and Outer Loop step=0. This command is set as the command 2.

Next, an address of a cycle 3 is “2”. The computer finds out as a result of trial and error that this address can also be accessed by the same command if Inner Loop step=1 and Inner Loop limit=2 are set in the previously generated command 2. Consequently, the computer changes the Inner Loop step to 1 and the Inner Loop limit to 2 of the previously generated command 2. This changed command is set as a command 2′.

Next, addresses of cycles 4 and 5 are “5” and “6”. The computer finds out as a result of trial and error that these addresses can also be accessed by the same command if Outer Loop step=4 and Outer Loop limit=2 are set in the previously generated command 2′. Consequently, the computer changes the Outer Loop step to 4 and the Outer Loop limit to 2 of the previously generated command 2′. This changed command is set as a command 2″.

Lastly, an address of a cycle 6 is “7”. This address cannot be represented by the previously generated command 2″. Consequently, the computer ends generation of the command 2″, and newly performs generation of a command 3. The computer finds out as a result of trial and error that this address can be accessed by a command of Base=7, Inner Loop limit=1, Inner Loop step=0, Outer Loop limit=1, and Outer Loop step=0. This command is set as the command 3.

The number of commands that the computer has generated by the above processing is three. In this example, each command can execute only 1 to 3 cycles of access. This means that the command is not necessarily efficient.

As described above, with the method in which the computer analyzes a target address string from a head thereof, and generates a conforming command, the command cannot be efficiently created depending on the address string. Namely, the number of commands may increase.

The present invention has been made to solve such a problem, and an object thereof is to provide an information processing method, an information processing program, and an information processing apparatus that can efficiently generate control information for an address generator.

### Solution to Problem

An information processing method pertaining to the present invention is an information processing method for utilizing an address generator that performs efficient memory access instead of a processor by converting a command input from the processor into an address string including a plurality of address block numbers by a predetermined algorithm, the information processing method comprising: processing that extracts an address string in a program that the processor executes performing memory access, and divides the address string into a plurality of sections; and processing that searches an address pattern accessible by the address generator for the each divided section.

A non-transitory computer readable medium pertaining to the present invention is a non-transitory computer readable medium having a program stored thereon, the program making a computer execute: processing that extracts an address string in a program that a processor executes performing memory access, and divides the address string into a plurality of sections; and processing that searches an address pattern accessible by an address generator that converts a command to be input into an address string including a plurality of address block numbers by a predetermined algorithm for the each divided section.

An information processing apparatus pertaining to the present invention is an information processing apparatus comprising control means, wherein the control means extracts an address string of memory access generated in a processor executing a program in an arbitrary computer, divides the address string into a plurality of sections, and searches an address pattern accessible by an address generator that converts a command to be input into an address string including a plurality of address block numbers by a predetermined algorithm for the each divided section.

### Advantageous Effects of Invention

According to the present invention, there can be provided an information processing method, an information processing program, and an information processing apparatus that can efficiently generate control information for an address generator.

### BRIEF DESCRIPTION OF DRAWINGS

FIG. 1 is a diagram showing a configuration of a generation apparatus of control information for an address generator pertaining to an embodiment 1.

FIG. 2 is a flow chart showing a processing flow of the generation apparatus of the control information for the address generator pertaining to the embodiment 1.

FIG. 3 is a table showing an address string that an address generator should access.

FIG. 4 is a diagram showing a configuration of a conventional address generator.

FIG. 5 is a diagram showing operation of the conventional address generator.

### DESCRIPTION OF EMBODIMENTS

### Embodiment 1

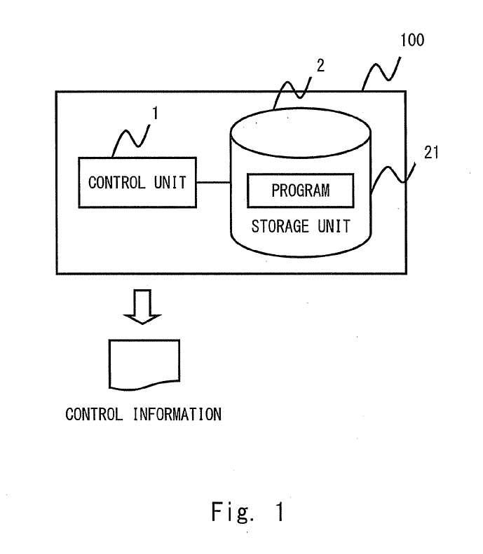

A configuration of an embodiment 1 of the present invention will be described using FIG. 1. A computer 100 of the embodiment 1 outputs control information, i.e., a command for a GAG by a control unit 1 executing a control information automatic generation program 21 recorded on a recording medium 2. The control information automatic generation program 21, as will be mentioned later, divides an address string, and executes processing of generating a command for each divided address string.

Here, the computer 100 is, for example, a PC (personal computer), and has a CPU, a ROM, a RAM, a hard disk, a display, a keyboard, a mouse, and the like. Alternatively, the computer 100 may be a server computer, a mobile terminal, or the like. In addition, the computer 100 does not need to be physically single, and may have a configuration in which a plurality of apparatuses distributedly execute processing. The control unit 1 is achieved by a CPU (central processing unit), a ROM (read only memory), a RAM (random access memory), an I/O (input/output) port, and the like, and has a function to execute various control based on various programs stored in the recording medium 2. The recording medium 2 is typically internal or external storage means, such as a ROM, a RAM, and a hard disk, and is connected to the control unit 1 by an internal or external bus, a communication network, or the like. The control information automatic generation program 21 is the program for making the CPU execute processing related to the embodiment, and is stored in the recording medium 2.

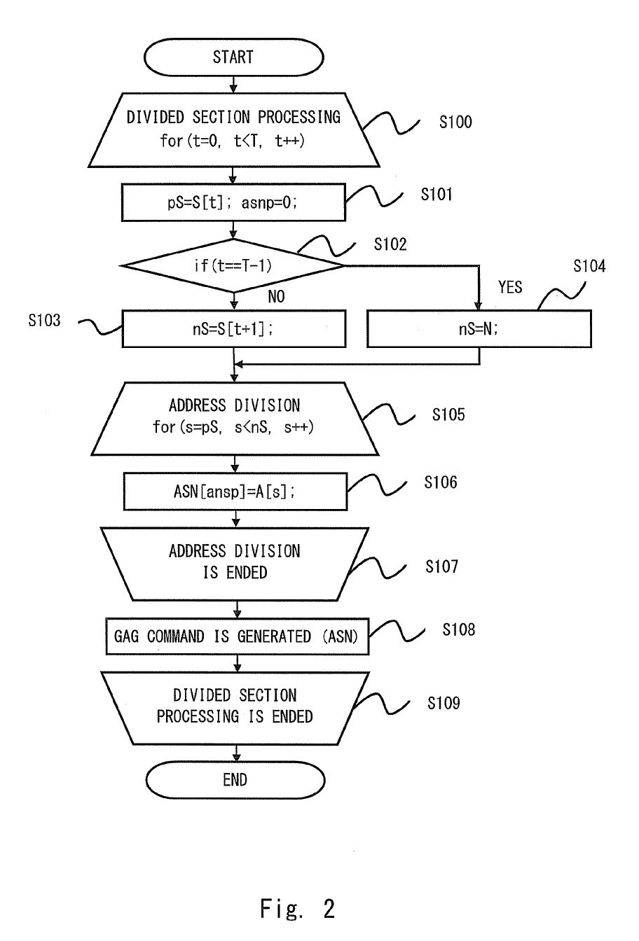

Processing pertaining to the embodiment 1 of the present invention will be described using a flow chart of FIG. 2. In the embodiment, the following processing is performed by the control unit 1 executing the control information automatic generation program 21 recorded on the recording medium 2.

First, there will be described a parameter used in processing pertaining to the embodiment. An address string that the GAG accesses is set as A. In addition, a length of the address string A is set as N, and an n-th element of the address string A is A[n]. In addition, when the address string A is divided into the arbitrary number of elements, the number of divisions is set as T, a start position of each divided section is {S0, . . . , and ST-1}, and an m-th element of the divided section start position is S [m]. In other words, the divided section start position S [m] indicates the position where the m-th divided section is started in the address string A. Furthermore, an address string divided from the address string A is set as ASN, and an o-th element of ASN is ASN [o]. In addition, processing in which a computer generates a command for a GAG to access the address string A is set as GAG command generation (A).

A content of the processing pertaining to the embodiment will be described. The computer 100 performs GAG command generation for each address string ASN obtained by dividing the address string A. Specifically, the control unit 1 of the computer 100 sets the number of divided sections T as the number of loops in S100 (S100). Subsequently, when each trial is set as t, the control unit 1 acquires a divided section start position S [t] and a next divided section start position S [t+1] (S101 and S103). It is to be noted that in a case of a last divided section, N is used instead of S [t+1] (S102 and S104). Next, the control unit 1 extracts as ASN sections of the address string A indicated by S [t] to S [t+1]-1 (S105 to S107). Lastly, a GAG command is generated using this ASN (S108). The above processing is executed throughout all the divided sections (S109).

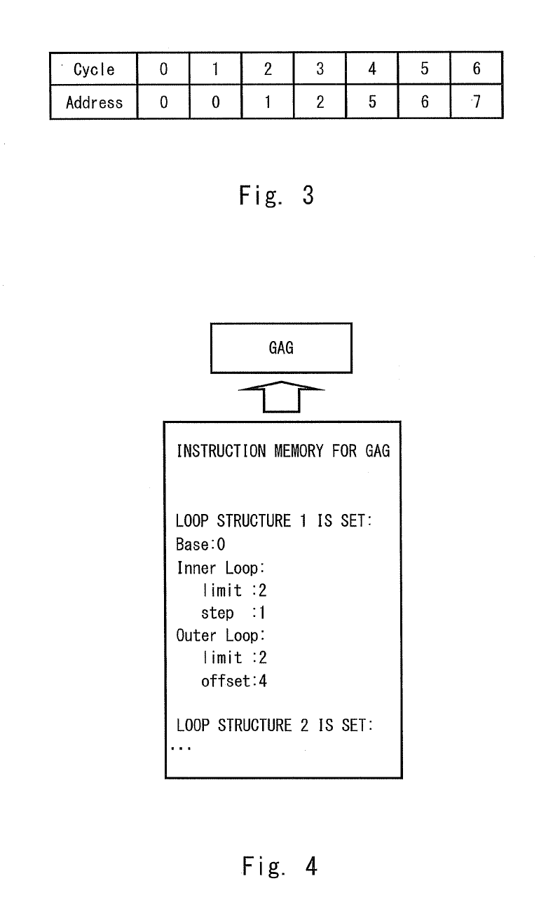

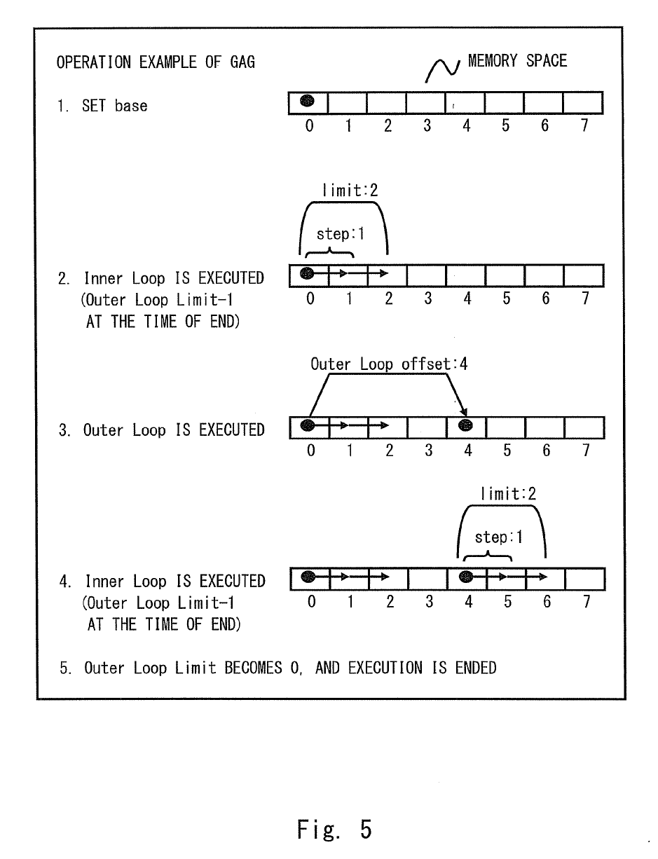

Next, there will be described an example where processing pertaining to the flow chart of FIG. 2 is applied to the address string shown in FIG. 3. In this example, the computer 100 divides the address string A of FIG. 3 into two. Assume that a division position is set between the cycle 0 and the cycle 1, and that the computer 100 performs command generation processing of two address strings made by the above-described division, respectively. Accordingly, in a case of this example, a length N of the address string A=7, the number of divisions T=2, and start positions S of the divided sections={0, 1}.

First, the control unit 1 of the computer 100 sets the number of divided sections T=2 as the number of loops (S100 of FIG. 2). Subsequently, the control unit 1 performs the first (t=0) loop processing. Here, a divided section start position S [0] corresponds to the cycle 0, and a next divided section start position S [1] corresponds to the cycle 1 (S101 and S103). Next, the control unit 1 extracts as ASN sections of the address string A indicated by S [0] to S[1]-1 (S105 to S107). In this case, ASN={0}. Lastly, a GAG command is generated using this ASN={0} (S108). A generation method of a GAG command here is the above-mentioned method in which the computer analyzes a target address string from a head thereof, and generates a conforming command. The control unit 1 finds out as a result of trial and error that this address can be accessed by a command of Base=0, Inner Loop limit=1, Outer Loop limit=1, Inner Loop Step=0, and Outer Loop Step=0. This command is set as the command 1.

Next, the control unit 1 performs the second (t=1) loop processing. Here, the divided section start position S [1] corresponds to the cycle 1 (S101). In addition, since this divided section is the last one, N=7 is used instead of S [t+1] (S104). Next, the control unit 1 extracts as ASN sections of the address string A indicated by S [1] to N−1=7−1=6 (S105 to S107). In this case, ASN={0, 1, 2, 5, 6, 7}.

Lastly, a GAG command is generated using this ASN={0, 1, 2, 5, 6, 7} (S108). The control unit 1 finds out as a result of trial and error that all these addresses can be accessed by a command of Base=0, Inner Loop limit=3, Outer Loop limit=2, Inner Loop Step=1, and Outer Loop Step=5. Here, since all the divided section processing is ended, processing ends (S109).

In the embodiment, the number of commands that the control unit 1 has generated is two. Meanwhile, in a case where the address string is not divided, the number of commands that the computer has generated is three. As described above, in the command generation according to the embodiment, the number of commands can be more suppressed.

### Other Embodiment

In the embodiment 1, the number of divisions, and a divided section start position are previously decided. Meanwhile, it is also possible that a command is generated trying the plural number of divisions and divided section start positions without previously deciding the number of divisions and the divided section start position, and to search and decide the number of divisions and the divided section start position in which the number of commands is the minimum in the trial.

As an example, although the number of divisions T is previously designated as 2 in the embodiment 1, the control unit 1 can change the number of divisions T in order from 1 to 2, 3, and . . . , and 8 to try command generation. Furthermore, command generation can be tried changing the division position S in each of the number of divisions T. For example, in a case of T=2, command generation is tried in all combinations that can be considered other than S={0, 1}, i.e., S={0, 2}, S={0, 3}, S={0, 4}, S={0, 5}, and S={0, 6}. These respective trial results are stored, and in all the trial being ended, the trial result in which the number of commands is the minimum is selected of all.

In this way, since the control unit 1 finds out the number of divisions and the divided section start position in which the number of commands is the minimum without previously deciding the number of divisions and the divided section start position, the more efficient number of commands for the GAG can be generated.

In addition, in the above-mentioned example, when a user is made to give an upper limit threshold C of the number of commands, and generation of the smaller number of commands than the threshold value C is succeeded in the above-described trials, the trials can be stopped.

As described above, since the control unit 1 halts processing at the time when a command satisfying the threshold value C that the user requires can be obtained, a command for the GAG having appropriate efficiency can be generated in a shorter time.

This application claims priority based on Japanese Patent Application No. 2011-079973 filed on Mar. 31, 2011, and the entire disclosure thereof is incorporated herein. In addition, the present invention is not limited to the above-described embodiment, it can be appropriately changed without departing from the subject matter. To a configuration and details of the invention of this application, can be made various changes that those skilled in the art can understand within the scope of the invention. For example, although the configuration of the present invention has been described as the configuration of the hardware in the above-mentioned embodiments, the present invention is not limited to this, and it is also possible to achieve arbitrary processing by making the CPU (Central Processing Unit) execute a computer program. In this case, the computer program is stored using various types of non-transitory computer readable media, and can be supplied to a computer. The non-transitory computer readable media include various types of tangible storage media. Examples of the non-transitory computer readable medium includes: a magnetic recording medium (for example, a flexible disk, a magnetic tape, a hard disk drive); a magneto-optical recording medium (for example, a magneto-optical disk); a CD-ROM (Read Only Memory); a CD-R; a CD-R/W; and a semiconductor memory (for example, a mask ROM, a PROM (Programmable ROM), an EPROM (Erasable PROM), a flash ROM, a RAM (random access memory)). In addition, the program may be supplied to the computer by a various types of transitory computer readable media. Examples of the transitory computer readable medium include an electrical signal, an optical signal, and an electromagnetic wave. The transitory computer readable medium can supply the program to the computer through a wired communication channel, such as an electric wire and an optical fiber, or a wireless communication channel.

Although some or all of the above-described embodiments can be set forth also as the following appendices, they are not limited to the following.

### APPENDIX 1

An information processing method for utilizing an address generator that performs efficient memory access instead of a processor by converting a command input from the processor into an address string including a plurality of address block numbers by a predetermined algorithm, the information processing method comprising:

processing that extracts an address string in a program that the processor executes performing memory access, and divides the address string into a plurality of sections; and

processing that searches an address pattern accessible by the address generator for the each divided section.

### APPENDIX 2

The information processing method according to Appendix 1, further comprising processing that outputs the command for generating the address pattern using the algorithm based on the address pattern found out by the search processing.

### APPENDIX 3

The information processing method according to Appendix 2, comprising:

processing that tries plural times the division processing, the search processing, and the command generation processing changing a position and the number of sections of the division; and

processing that selects and outputs one command of the commands generated as a result of the trial processing based on indexes indicating degrees that the commands make efficient the memory access of the processor.

### APPENDIX 4

The information processing method according to Appendix 2, comprising:

processing that tries plural times the division processing, the search processing, and the command generation processing changing a position and the number of sections of the division; and

processing that determines whether or not the generated command conforms to indexes indicating degrees of making efficient the memory access of the processor whenever the command generation processing is executed in the trial processing, halts the trial processing when the generated command is determined to conform to the indexes, and outputs the command determined to conform thereto.

### APPENDIX 5

A non-transitory computer readable medium having a program stored thereon, the program making a computer execute:

processing that extracts an address string in a program that a processor executes performing memory access, and divides the address string into a plurality of sections; and

processing that searches an address pattern accessible by an address generator that converts a command to be input into an address string including a plurality of address block numbers by a predetermined algorithm for the each divided section.

### APPENDIX 6

The non-transitory computer readable medium having the program stored thereon according to Appendix 5, the program further making the computer execute

processing that outputs the command for generating the address pattern using the algorithm based on the address pattern found out by the search processing.

### APPENDIX 7

The non-transitory computer readable medium having the program stored thereon according to Appendix 6, the program making the computer execute:

processing that tries plural times the division processing, the search processing, and the command generation processing changing a position and the number of sections of the division; and

processing that selects and outputs one command of the commands generated as a result of the trial processing based on indexes indicating degrees that the commands make efficient the memory access of the processor.

### APPENDIX 8

The non-transitory computer readable medium having the program stored thereon according to Appendix 6, the program making the computer execute:

processing that tries plural times the division processing, the search processing, and the command generation processing changing the position and the number of sections of the division; and

processing that determines whether or not the generated command conforms to the indexes indicating the degrees of making efficient the memory access of the processor whenever the command generation processing is executed in the trial processing, halts the trial processing when the generated command is determined to conform to the indexes, and outputs the command determined to conform thereto.

### APPENDIX 9

An information processing apparatus comprising control means, wherein

the control means extracts an address string of memory access generated in a processor executing a program in an arbitrary computer,

divides the address string into a plurality of sections, and

searches an address pattern accessible by an address generator that converts a command to be input into an address string including a plurality of address block numbers by a predetermined algorithm for the each divided section.

### APPENDIX 10

The information processing apparatus according to Appendix 9, wherein the control means further performs processing that outputs the command for generating the address pattern using the algorithm based on the address pattern found out by the search processing.

### APPENDIX 11

The information processing apparatus according to Appendix 10, wherein

the control means performs processing that tries plural times the division processing, the search processing, and the command generation processing changing a position and the number of sections of the division, and

processing that selects and outputs one command of the commands generated as a result of the trial processing based on indexes indicating degrees that the commands make efficient the memory access of the processor.

### APPENDIX 12

The information processing apparatus according to Appendix 10, wherein

the control means performs processing that tries plural times the division processing, the search processing, and the command generation processing changing the position and the number of sections of the division, and

processing that determines whether or not the generated command conforms to the indexes indicating the degrees of making efficient the memory access of the processor whenever the command generation processing is executed in the trial processing, halts the trial processing when the generated command is determined to conform to the indexes, and outputs the command determined to conform thereto.

### INDUSTRIAL APPLICABILITY

The present invention relates to an information processing method, a non-transitory computer readable medium having a program stored thereon, and an information processing apparatus and, in particular, to an information processing method, a non-transitory computer readable medium having a program stored thereon, and an information processing apparatus that can efficiently generate control information for an address generator.

### REFERENCE SIGNS LIST

100 COMPUTER
1 CONTROL UNIT
2 RECORDING MEDIUM
21 CONTROL INFORMATION AUTOMATIC GENERATION PROGRAM

What is claimed is:

1. An information processing method for utilizing an address generator that performs efficient memory access instead of a processor by converting a command input from the processor into an address string including a plurality of address block numbers by a predetermined algorithm, the information processing method comprising:
processing that extracts an address string in a program that the processor executes performing memory access, and divides the address string into a plurality of sections; and
processing that searches an address pattern accessible by the address generator for the each divided section.

2. The information processing method according to claim 1, further comprising processing that outputs the command for generating the address pattern using the algorithm based on the address pattern found out by the search processing.

3. The information processing method according to claim 2, comprising:
processing that tries plural times the division processing, the search processing, and the command generation processing changing a position and the number of sections of the division; and
processing that selects and outputs one command of the commands generated as a result of the trial processing based on indexes indicating degrees that the commands make efficient the memory access of the processor.

4. The information processing method according to claim 2, comprising:
processing that tries plural times the division processing, the search processing, and the command generation processing changing the position and the number of sections of the division; and
processing that determines whether or not the generated command conforms to the indexes indicating the degrees of making efficient the memory access of the processor whenever the command generation processing is executed in the trial processing, halts the trial processing when the generated command is determined to conform to the indexes, and outputs the command determined to conform thereto.

5. A non-transitory computer readable medium having a program stored thereon, the program making a computer execute:
processing that extracts an address string in a program that a processor executes performing memory access, and divides the address string into a plurality of sections; and
processing that searches an address pattern accessible by an address generator that converts a command to be input into an address string including a plurality of address block numbers by a predetermined algorithm for the each divided section.

6. The non-transitory computer readable medium according to claim 5, the program making a computer execute further comprising processing that outputs the command for generating the address pattern using the algorithm based on the address pattern found out by the search processing.

7. The non-transitory computer readable medium according to claim 6, the program making a computer execute comprising:
processing that tries plural times the division processing, the search processing, and the command generation processing changing a position and the number of sections of the division; and
processing that selects and outputs one command of the commands generated as a result of the trial processing based on indexes indicating degrees that the commands make efficient the memory access of the processor.

8. The non-transitory computer readable medium according to claim 6, the program making a computer execute comprising:
processing that tries plural times the division processing, the search processing, and the command generation processing changing the position and the number of sections of the division; and
processing that determines whether or not the generated command conforms to the indexes indicating the degrees of making efficient the memory access of the processor whenever the command generation processing is executed in the trial processing, halts the trial processing when the generated command is determined to conform to the indexes, and outputs the command determined to conform thereto.

9. An information processing apparatus comprising:
a control unit extracts an address string of memory access generated in a processor executing a program in an arbitrary computer,
divides the address string into a plurality of sections, and
searches an address pattern accessible by an address generator that converts a command to be input into an address string including a plurality of address block numbers by a predetermined algorithm for the each divided section.

10. The information-processing apparatus according to claim 9, wherein the control unit further performs processing that outputs the command for generating the address pattern using the algorithm based on the address pattern found out by the search processing.
